(19) United States
(12) Patent Application Publication
(10) Pub. No.: US 2008/0126492 A1
(43) Pub. Date: May 29, 2008

(54) Pinging for the Presence of a Server in a Peer to Peer Monitoring System

(75) Inventors: Jarno Guidi, Eindhoven (NL); Johannes Gorter, Enschede (NL); Alexander Wilhelmus Heerink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,600

(22) PCT Filed: Aug. 30, 2005
(86) PCT No.: PCT/IB05/52827

§ 371 Date: Mar. 2, 2007

(30) Foreign Application Priority Data
Sep. 7, 2004 (EP) 04104298.7

(51) Int. Cl. G06F 15/16

(52) U.S. Cl. 709/206

(57) ABSTRACT

A system that comprises a dynamically changing set of client and server devices (10). Client devices send detection messages (64a, 66a, 68a) to a server device (10), for detecting active presence of the server device (10) in the system. The server device (10) selects assigned time points for transmission of subsequent detection messages from respective ones of the client devices (10). The server device sends timing information that represents the selected time points (10) to the client devices (10) in response to the detection messages (64a, 66a, 68a).The client devices send renewed detection messages (646,c, 66b, 68b), using the timing information to time sending of the renewed detection messages (646,c, 66b, 68b) substantially at the assigned time points.

The invention relates to an information exchanging system that comprises a dynamically changing set of devices, to a method of operating such a system and to devices for such a system.

A paper submitted at the IEEE CCNC conference 2004 (Las Vegas), titled “Enhancing Discovery with Liveness” by Maarten Bodlaender, Jarno Guidi and Lex Heerink describes a system with a dynamically changing set of devices. Examples of such a system occur in home and office environments where there are many devices such as television sets, printers, storage devices, remote controls, portable information access devices such as media players, palmtop computers etc. These types of devices may be connected by wired and/or wireless networks, to form a system wherein the different devices can communicate with each other. Devices can become active in such a system when they are plugged into the system, or carried into an area covered by the wireless connection, or when they are switched on. Conversely the devices can be deactivated by switching off power, carrying the devices away or by unplugging the devices from the system.

For optimal operation of such a variable system it is desirable that the devices have up to date information about the presence of other devices that are available in the system, in particular about other devices that may be used to perform remote functions for a device. Collection of this presence information is performed by sending probe messages to detect the presence of devices. Preferably, presence information should be collected in a distributed way, by more than one device, to ensure robustness against removal of the collecting devices from the system.

The CCNC conference paper proposes a solution to this problem that makes use of a so-called “liveness ping protocol” and a “proxy-bye protocol”. The paper distinguishes two types of devices: clients and servers. Servers are devices that are able to perform functions at the commands of clients. Hence, from the liveness protocol perspective, clients are interested in knowing about devices availability. According to the “liveness ping protocol” each client sends ping messages (messages that request sending of a return message to confirm its presence) to a server about which it wants updated presence information. In response the server, if present, returns a ping response message to the client. When the client has not received a ping response message to a ping message within a predetermined timeout interval, the client sends a new ping message. This is repeated a predetermined number of times until the client decides that the server is not actively present and updates its presence information accordingly.

One potential problem with this type of “liveness ping protocol” is that it may create considerable network bandwidth occupation and server load if there are many clients that attempt to keep their presence information about the same server highly up to date.

The CCNC conference paper addresses this problem by combining the liveness protocol with the proxy bye protocol. In the ping response message the server includes the network addresses of the last two previous clients that have sent ping messages to the server. The client that receives the ping response message stores these network addresses. Later, when the client decides that the server is no longer connected, it notifies the clients whose network addresses it has stored. These clients forward the notification to the clients for which they store network addresses and so on.

Owing to the proxy bye protocol a client is kept up to date about the presence of servers even if the frequency with which the client sends ping messages is reduced. Therefore the bandwidth occupied by ping messages can be reduced, by reducing the frequency with which a client sends ping messages, without significantly affecting the up to date-ness of the information about the presence of servers.

The CCNC conference paper proposes to control the network bandwidth occupation and device load by including “pingcount” information in the ping response messages. Each time when the server sends a ping response message, the server increases the pingcount. The client compares the pingcount with the pingcount from the last previously received ping response message. The difference is indicative of the number of clients that send ping messages to the server during the time interval in between of two consecutive pings from the same client. The client adjusts the delay between sending of successive ping messages in proportion to the difference between the pingcounts.

In this way it can be realized that ping messages from all clients together occupy a predetermined fixed bandwidth on average. By means of simulations, however, it has been found that this technique leads to fluctuating bandwidth occupation, resulting in congestion peaks that can adversely affect system performance. One reason for this has been found to be that it requires a number of ping response messages to a client before a stable time interval is established. Moreover, it has been found that a satisfactory implementation of this protocol in clients can considerably increase the complexity of the clients.

Among others, it is an object of the invention to provide for a method of keeping presence information up to date which leads to a more predictable device load and/or bandwidth use.

A method, system, server device and client device according to the invention are set forth in the independent claims. A plurality of client devices in the system send detection messages (also called “ping messages”) to a server device to detect whether the server device remains actively connected to the system. According to the invention the server device selects the time points at which the different client devices will send subsequent detection messages and send timing information that represents these time points to the client devices, typically as part of response messages to the detection messages, with which the server device confirms its continued active presence in the system. In this way, the server device has control over the future bandwidth use for subsequent detection messages to detect its presence. This simplifies bandwidth control in comparison with the prior art situation wherein the client devices each attempt to adapt to the bandwidth occupation. Preferably this is combined with a proxy bye mechanism, whereby the client devices that detect the absence of the server device at the assigned time report that absence to fellow client devices.

When there is a plurality of different server devices, each particular server device preferably selects the time points for those client devices that send detection messages to that particular server device.

Preferably, the server device selects the time points for all of a plurality of client devices from a common series of time points that are progressively further into the future, so that in response to detection messages that are successively received from different client devices successive time points are assigned from the common series. Preferably, this applies only once per distinguished received detection messages. When the server device detects a retry of transmission of a detection message, the server device preferably repeats previously sent timing information.

Preferably, the server device computes time point values T for successive time points in the series by adding duration values D to a preceding time point value T′ from the series (typically the last preceding time point value in the series). In this way the server device merely needs to keep information about the time value of the last sent response, or of a few last sent responses.

In a simple embodiment the duration value D may have a fixed predetermined value, so that successive assigned time points are equidistant from each other. In another embodiment the server device adapts the duration value to the number of different client devices, for example so that the frequency of detection messages is regulated to a specific average frequency subject to the constraint that client devices get a minimum predetermined time between successive detection messages. An initial time point value T for an initial time point in the series may be formed by adding the duration value D to a current time value T₀.

In a further embodiment the timing information that is sent in response to successively received detection messages is selected from at least a first and a second series of time points. In this embodiment timing information from the second series is sent in response to a rate limiting fraction of the detection messages, so that a rate at which time points from the second series are transmitted at least on average does not exceed a predetermined rate, irrespective of a rate of reception of the detection messages. The rate may be limited for example by adding a new time point to the second series only if a last previous time point in the second series is less than a predetermined time interval in the future from the current time.

These and other objects and advantageous aspects of the invention will be described in more detail by means of non-limiting examples using the following figures.

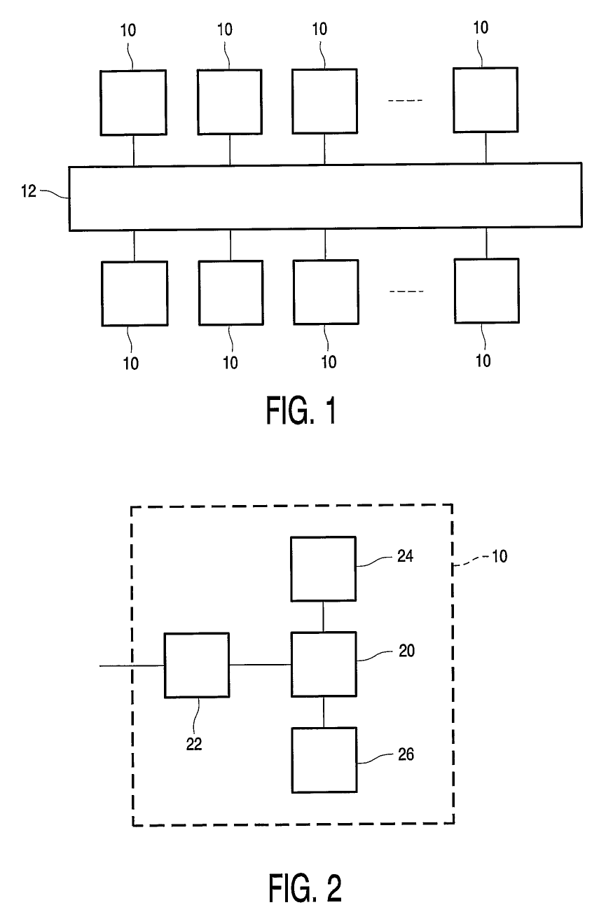

FIG. 1 shows a system with a plurality of devices;

FIG. 2 shows a device for use in the system;

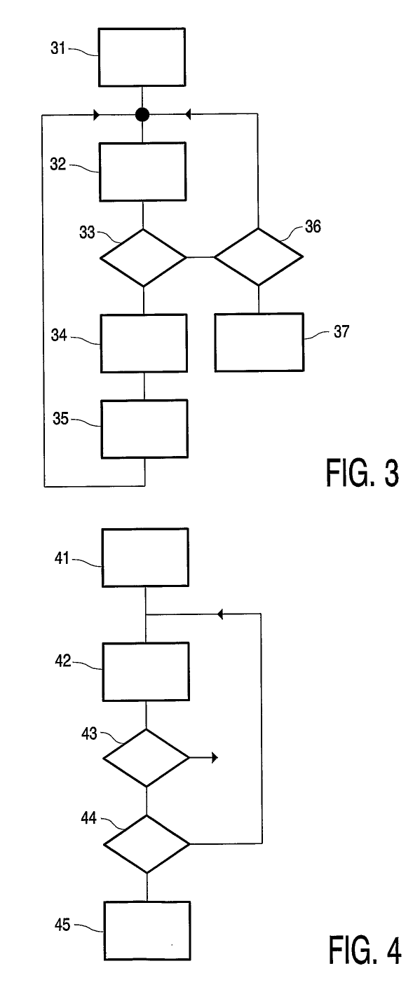

FIG. 3 shows a flow chart of an operation of a client;

FIG. 4 shows a flow chart of a further operation of a client;

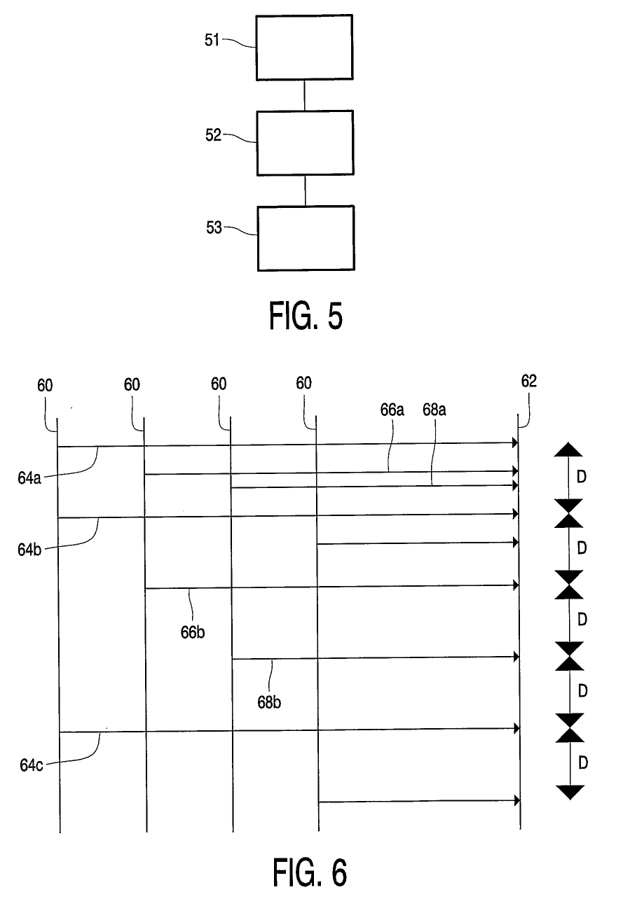

FIG. 5 shows a flow chart of operation of a server;

FIG. 6 shows a timing diagram of ping messages and responses.

FIG. 1 shows a system containing a plurality of devices 10 interconnected by a communication medium 12. Communication medium 12 can be a wired communication network for example or a wireless communication network or a combination of both. Devices 10 can enter and leave the system dynamically, for example by switching selected devices on or off, attaching devices 10 to medium 12 or detaching devices 10 from medium, or by moving wireless devices 10 into or out of a reception range.

Devices 10 include for example handheld remote control devices, television sets, audio/video storage devices, portable audio/video players, personal computing devices etc. In an office environment devices 10 may include printers, storage devices, personal computers, portable computers, laptops, palmtops, scanners etc. Although a small number of devices 10 is shown by way of example it should be understood that in practical systems many more clients may be present.

FIG. 2 shows a device 10. The device 10 contains a processor 20 coupled to a network interface 22, a clock circuit 24 and a memory 26. Processor 20 is typically a programmable processor, programmed with a program that causes processor 20 to perform the operations described in the following. However, as an alternative a dedicated logic circuit may be used, designed to perform these operations.

In operation devices 10, when active, determine which type of services they may need to request. Devices 10 that may require a service will be called “clients”. Devices 10 that are able to perform these services will be called “servers”.

An example of a client is for example a laptop computer that is a client of a file server service provided by storage devices, the laptop computer keeping a list of available storage devices. A handheld remote control device, as another example, may be a client that maintains the addresses of servers like a television set and/or a video/audio storage device that are within reach to perform commands entered in the remote control device. As yet another example a portable audio and or video rendering device may be a client of a nearby storage device for audio/video content.

Each client 10 maintains a list of addresses of one or more active servers 10. It may be noted that a device 10 may be a client and a server at the same time for different services. Likewise a device 10 may be a client of more than one type of service and/or a server for more than one type of service.

FIG. 3 shows a flow chart of a process executed by a client. In a first step 31 processor 20 of a client records (e.g. in memory 26) the address of a server 10 that is able to perform a service that the client 10 may need, after “discovering” the active presence of the server 10 in the system. This discovery process is not the subject of the present invention. Many solutions exist, involving for example sending a multicast message from the client 10 generally addressed to all servers of a certain type and receiving back responses and/or receiving multicast messages, which are sent by servers when they become an active part of the network and/or periodically, generally addressed to all clients of a certain service.

Subsequent steps of the flow-chart are used to the list of discovered clients up to date. In a second step 32 processor 20 of client 10 causes interface 22 to send a “ping message” addressed to a server from the list. The term “ping” is a conventional term in the art, used to refer to a message with no other purpose that eliciting a response. In a third step 33 processor 20 tests whether a ping response message has been received in reply to the ping message within a predetermined response time interval. If so, processor 20 proceeds to a fourth step 34 wherein processor extracts a representation of a time point T and addresses of fellow clients from the ping response message and records this information in memory 26. Next, in a fifth step 35 processor 20 waits until clock circuit 24 indicates that the specified time point T has been reached. The time point T is preferably specified by means of a delay count Q of clock pulses that must be counted before the next ping message can be sent. When the time to send the next ping message has arrived processor 20 returns to the second step 32.

If processor 20 does not detect a ping reply message within the response time interval in second step 32, processor 20 executes a sixth step 36, returning to second step 32 if no more than a predetermined successive ping messages have not resulted in a ping response message. When more than the predetermined successive ping messages has not resulted in a ping response message, processor 20 executes a seventh step 37. It will be appreciated that the return to the second step 32 after a failure to receive a ping response message is merely a safety measure for the case that there is a significant risk that ping messages and/or ping response messages get lost. The greater the risk, the more returns to second step 32 are used preferably. If there is no significant risk of this seventh step 37 may be executed immediately.

In seventh step 37 processor 20 removes the server address from its list of actively present servers and sends “proxy bye messages” to the addresses of the fellow clients that have been indicated in a last received ping response message, if any from the server. In the proxy-bye message, the client 10 includes the server address to notify the fellow clients that no ping response message was received from the server with that server address. Preferably, the client 10 also adds information about the time at which was expected to check the device by means of a ping message. This information enables other clients to detect if current proxy bye message is old with respect of previously received proxy bye messages and/or with respect to other clients' ping messages.

FIG. 4 shows a flow chart of a process executed by a client when it receives a proxy-bye message. In a first step 41 processor 20 detects the proxy-bye message for a server. If the server is still listed as an active server in the client 10, processor 20 executes a second step 42 sending a ping message to the server.

In a third step 43 the processor 20 detects whether a ping response message is received. If so, the process terminates. If not processor executes a fourth step 44, repeating from second step 32 if no more than a predetermined number of ping messages have been sent. If more than the predetermined number of ping messages has been sent processor 20 executes fifth step 45, which is similar to seventh step 37 of FIG. 3, removing the server address from its list of actively present servers and sending “proxy bye messages” to the addresses of the fellow clients that have been indicated in a last received ping response message, if any.

Several further steps may be added. For example, client 10 preferably checks whether the proxy bye message was already received. If so, client 10 discards the message and terminates the process of the flow-chart. Furthermore, the proxy bye message may contain information about the time when the client that has sent the proxy-bye was expected to execute the ping action. Based on this information, client 10 may check whether a more recent ping action was successfully completed. If so, then the proxy bye message carries outdated information, in which case client 10 discards the message.

It will be appreciated that the second step 42 is merely a precaution against erroneous or even intentionally faked proxy bye messages. When there is no significant risk of such messages, second step 42 may be skipped, the process moving from the first to the fifth step immediately. Similarly, the return to the second step 42 after a failure to receive a ping response message is merely a safety measure for the case that there is a significant risk that ping messages and/or ping response messages get lost. The greater the risk, the more returns to second step 42 are used preferably. If there is no significant risk the fourth step may be skipped.

FIG. 5 shown a flow chart of a process executed by a server when it receives a ping message. In a first step 51 processor 20 of the server detects the ping message and records the address of the sender of the ping message in memory 26; in principle only a predetermined number of sender addresses from most recently received ping messages need be kept.

In a second step 52 processor 20 computes a time value T that it will assign to the sending client. In one embodiment processor 20 keeps a last previously assigned time value T′ in memory 26 and computes the newly assigned time value T by adding a predetermined duration D to that previously assigned time value T′, subsequently replacing the stored previously assigned time value by the newly assigned time value T. In this embodiment, if no assigned time value T′ is stored, or the stored time value T′ precedes the current time T₀ indicated by clock circuit 24, processor 20 selects the newly assigned time value T by adding the predetermined duration to the current time value T₀ indicated by clock circuit 24.

In a third step 53 processor 20 causes interface 22 to send a ping response message to the address of the client that has sent the ping message that was detected in first step 51. In the ping response message processor 20 includes a representation of the assigned time value T, e.g. as difference value T−T₀ with the current clock time indicated by clock circuit 24, or simply as a time value T. Furthermore, processor 20 includes the addresses of a number of other clients that have last sent ping messages in the ping response message. The representation of the assigned time value T and the address are included for example at respective predetermined bit distances from the start of the ping response message, or preceded by labels, so that the client will be able to extract this information from the ping response message.

FIG. 6 shows a timing diagram of ping messages and ping response messages that are exchanged in this way. Increasing time is represented by successively lower position in the figure. Vertical lines 60 correspond to different clients vertical line 62 corresponds to a server. Horizontal lines 64a-c, 66a,b, 68a,b correspond to ping messages.

The first ping messages from a first client can occur at any time, but subsequent ping messages from that first client occur at times selected by the server, so that a time interval with predetermined duration D occurs between successive ping messages from any clients. In the example the server responds to a first ping message 64a from a first client by assigning a time that is a duration D from the first ping message 64a. The server communicates the assigned time to the first client in the ping response message (not shown) and the first client sends its next ping message 64b according to the assigned time, with after a duration D from the first ping message 64a.

Between transmission of the first and second ping message 64a,b, the server receives first and second intervening ping messages 66a, 68a from a second and third client. In response to the first intervening ping message the server assigns a new time that is a duration D later than the last previously assigned time (the time of second ping message 64b). This new time is represented in the ping response message to the second client in response to the first intervening ping message 66a. In response the second client will send its next ping message 66b a duration D after the second ping message 64b from the first client.

In response to the second intervening ping message 68a the server assigns a new time that is a duration D later than the last previously assigned time (the time of next ping message 66b). This new time is represented in the ping response message to the third client in response to the second intervening ping message 68a. In response the third client will send its next ping message 68b two durations D after the second ping message 64b from the first client.

When the server receives the second ping message 64b from the first client, it has already assigned two new times for sending subsequent ping messages. Therefore, the server now assigns a time that is three durations D later than the second ping message 64a and represents the assigned time in the ping response message to the second ping message 64b. In response the first client sends a third ping message 64c at the assigned time.

It should be noted that in this way the server makes the time distance between successive ping messages from a client depend on the number of clients that are sending ping messages. In the embodiment shown the assigned times are distributed equally over the different clients. If a client leaves the system it will of course not send its next ping message. This means that one assigned time will lapse without a ping message. However, because the assigned times are distributed among the clients, the next assigned time another client (if any) will send a ping message. In this way the risk is minimized that the departure of the server from the system will go unnoticed due to departure of a client.

Although the invention has been described for a specific embodiment, it should be realized that other embodiments are possible. For example, in the embodiment predetermined durations D between assigned times were used. In other embodiment this time may be variable.

This may be used to provide a lower limit Iₘᵢₙ on the time interval between two successive transmissions of ping messages from the same client. Of course such a lower limit can be set by selecting D=Iₘᵢₙ. However, this is only needed when there are few clients. If there are many clients, such a long duration D has the effect that ping messages will be sent at unnecessarily low frequencies. According to one aspect of the invention, the duration D is progressively decreased when there is an increasing number of pinging clients.

For example the server may use an estimated count N of a current number of different clients that send ping messages. In this case the duration D may be set for example according to

D=Iₘᵢₙ/N

A minimum duration Dₘᵢₙ may be imposed by setting

D=Dₘᵢₙ if<Dₘᵢₙ>Iₘᵢₙ/N.

Preferably, the use of explicit counting of the number N of current clients is avoided. Instead a difference (T−T₀) may be used, wherein T is the last assigned transmission time and T₀ is the current time and “c” is a constant smaller than one e.g. c=0.5. The difference (T−T₀) is a measure of the number of clients: when there are more clients more transmission times will have been assigned so that the last assigned transmission time is higher.

For example, the duration may be selected according to

D=Iₘᵢₙ−c*(T−T₀)

Herein “c” is a constant smaller than one e.g. c=0.5. In this way the duration D will vary. By means of mathematical analysis it can be shown that when there are N clients D will stabilize at

D=Iₘᵢₙ/(c*N+1−c)(=2 Iₘᵢₙ/(N+1) when c=0.5).

The resulting time interval I between two ping messages from the same client is

I=N*Iₘᵢₙ/(c*N+1−c)(=2 N*Iₘᵢₙ/(N+1) when c=0.5).

As can be seen this makes it possible to keep the time interval I roughly between Iₘᵢₙ and Iₘᵢₙ/c.

In another example a factor F is used, and D is set according to

D=Iₘᵢₙ/F

The factor F may be set to 1 initially and increased in steps when T−T>Iₘᵢₙ until some predetermined maximum is reached. When T−T₀<Iₘᵢₙ the factor may be increased which is computed according to

F=Iₘᵢₙ/(Iₘᵢₙ−(T−T₀))

so that the next assigned time T+D becomes (Iₘᵢₙ+T₀), which ensures the minimum time interval. Various refinements may be applied, such as selecting F as the minimum of its previous value plus 1, a maximum value and Iₘᵢₙ/(Iₘᵢₙ−(T−T₀)).

As another example, the server may use a feedback control to regulate D to a desired value Dₐᵥ as long as T−T₀>Iₘᵢₙ.

It should be clear that various embodiments are possible also at other points. For example instead of using a single series of assigned transmission times obtained by adding a duration D to the last previously assigned transmission time T, a plurality of series of transmission times may be used. So for example transmission times for a first series may be obtained by adding a duration D₁ to the last assigned transmission time T₁ of the first series and transmission times for a second series may be obtained by adding a duration D₂ to the last assigned transmission time T₂ of the second series.

This may be used for example to keep the fraction of ping messages to which a ping response with a time point from the second series is sent so low that the time interval between sending the ping response message and the ping messages at these assigned time is limited to a maximum value independent of the number of clients. Thus, it is ensured that in selected instances clients will send a new ping message quickly. This has the advantage that the system need not rely only on clients that have sent their last ping message a long time in the past, with the risk that many of these clients are no longer active.

To realize this, the server may insert a transmission time T₁ or T₂ from a selected one of the series in each ping response message. For example a transmission time T₂ from the second series only if this transmission time is no more than a predetermined time interval after the current time. As another example, the series may be selected at random for example, with a higher probability of selecting the first series than the second series. The frequency with which the second series is selected may be limited to below a predetermined frequency, for example.

Also, server may send ping response messages representing the same assigned transmission time T to a plurality of clients. For example, the server may be arranged to increment the value T each time only after it has sent a predetermined number P of ping response messages to ping messages, or the server may be arranged to increment the values T each time only by a value smaller than D for the P ping response messages (preferably the value T is increased in any case when if a new ping message is received from a same client after less than P ping messages). In this way P clients will send ping messages substantially simultaneously each time, but otherwise operation will remain the same. In this way the risk is reduced that it is not detected promptly that the server is no longer active.

Furthermore, although the simplest implementation is to compute the next time value T from the last preceding assigned time value T′, without deviating from the invention a similar effect may of course be realized by adding an integer multiple KD of the duration D to a time value that has been assigned K response into the past.

It should be appreciated that the use of delay values D represents only one embodiment of the invention in another example predetermined (e.g. evenly spaced) time slots may be defined by the system for ping messages. In this case each ping response message needs merely specify the number of the time slot in which the client is allowed to send the next ping message.

Other embodiments are possible also at other points. For example, in a further embodiment, a client may be arranged to insert a requested minimum duration in its ping messages. In this embodiment, the server may be arranged to assign transmission times so that the time interval between the current time and the assigned time exceeds the requested minimum duration. Thus, different clients may request different durations.

In another embodiment, the server preferably is arranged to disable incrementation of the assigned time T in response to a ping message if the server detects that the ping message is a retry message for a client to which the server has just sent a ping response message. Various techniques may be used to detect retries. For example, a client may be arranged to include information in its ping messages to indicate whether the ping message is a first ping message or a retry after a failure to receive a ping response message. Alternatively, a client may be arranged to include a transmission time value in the ping message, the transmission time value of an original ping message being included in the retries of that original message. In this case the server may be arranged to disable incrementation of the assigned time T if the transmission time value from a ping message equals a previous transmission time value.

The number of addresses of fellow clients that the server includes in a ping response message is for example M=2, but one or a larger number M may be used. The large the number the smaller the risk that the proxy bye message will not reach all relevant clients. Preferably, for this purpose the server stores addresses of the M last clients that have sent ping messages. Each time when the server receives a new ping message it uses the address of the client that has sent that message to replace the oldest stored client address. However, alternatively other criteria for selecting the addresses could be used, for example by replacing one stored address at random.

It should be appreciated that clients may send other messages than ping messages, for example a message to command execution of a service, to request status information, or to supply data. Similarly, the servers may send other messages than ping response messages, for example messages to supply data requested by the clients. Typically the ping message/ping response messages run independent of these other messages, ping messages/ping response messages being at most suppressed when it is clear from the other messages that the server is still actively present. In another embodiment, information that is normally included in the ping messages (and/or ping response messages) is included in the other messages, if such other messages are sent.

Preferably, the server represents the assigned time T in a ping response message as a delay value from the current time. In this case the client preferably counts clock pulses until this delay has expired before sending a next ping message. Alternatively, the server may represent the time as a clock time value. Use of a delay has the advantage that the client does not need to maintain clock time values. In case delta timing values are used, the device may provide its current absolute time so that all clients can estimate device clock drift with respect to clients clocks and adapt to it. Moreover, having the current time of the device clock and the delta time to be waited before next ping action allows client to indicate in proxy bye messages when the ping action failed with respect to device time. This enables effective fake or old proxy bye detection, reducing the number of ping action required after receiving proxy bye message and speeding up the proxy bye message notification procedure.

From the preceding it will be appreciated that the invention provides for a distributed mechanism to detect whether previously detected servers remain actively present in a system. The mechanism controls the frequency with which ping messages are sent, at the same time ensuring that many different clients of a server keep sending ping messages, so that the mechanism does not fail if any single client stops participating. The server that receives the ping messages is used to select the time points at which the different clients will send ping messages to the server. Information that represents the selected time points is included in the ping response messages. The clients of the server receive the information from the ping response messages and preferably use the information to control timing of the next ping message. However, it should be appreciated that the mechanism does not fail if clients deviate from the specified time. If at some instance a client sends no new ping message at a specified time a possible departure of the server will be detected anyway when another client sends a ping message at a next specified time. This holds in particular if the new ping message is sent no more than a duration D too early or too late. Similarly, if a client sends a ping message much earlier, this may needlessly increase message traffic, but it does not break down the mechanism.

1. A method of operating a system that comprises a dynamically changing set of devices (10), the method comprising:
sending detection messages (64a, 66a, 68a) from a plurality of testing devices (10) to a tested device (10), for detecting active presence of the tested device (10) in the system;
selecting assigned time points for transmission of subsequent detection messages from respective ones of the testing devices (10);
sending timing information that represents the selected time points from the tested device (10) to the testing devices (10) in response to the detection messages (64a, 66a, 68a);
sending renewed detection messages (64b,c, 66b, 68b) from the plurality of testing devices (10), the testing devices (10) using the timing information to time sending of the renewed detection messages (64b,c, 66b, 68b) substantially at the assigned time points.

2. A method according to claim 1, wherein assigned time points for all of the plurality of testing devices (10) are selected from a common series of time points that are progressively further into the future in a sequence corresponding to a sequence of arrival of the detection messages (64a, 66a, 68a).

3. A method according to claim 2, wherein time point values T for successive assigned time points in the series are computed by adding a duration value D to time point values T′ for preceding time points from the series.

4. A method according to claim 3, wherein said duration value D has a predetermined value.

5. A method according to claim 3, wherein said duration value D is adapted dynamically to a number of testing devices (10) that send detection messages, so that the duration is increased and decreased as the number of testing devices (10) decreases or increases respectively, while ensuring that no less than a predetermined minimum time interval occurs between successive assigned time points of a particular testing device (10).

6. A method according to claim 3, wherein an initial time point value T for an initial time point in the series is formed by adding the duration value D to a current time value T₀.

7. A method according to claim 1, wherein timing information that is sent in response to successively received detection messages is selected from at least a first and a second series, each series representing time points that are progressively further into the future, timing information from the second series being sent in response to a delay limiting fraction of the detection messages, so that a delay, between the time points of the second series from times at which time points from the second series are transmitted, at least on average does not exceed a predetermined delay, irrespective of a rate of reception of the detection messages.

8. A method according to claim 1, comprising detecting whether a detection message received at the tested device is a retry of a detection message that was previously received at the tested device and resending previously sent timing information in response to the retried detection message upon said detection.

9. A system that is arranged to accommodate a dynamically changing set of devices, the system comprising:
a communication medium (12);
a server device (10) coupled to the medium to receive detection messages (64a, 66a, 68a) for detecting an active connection of the server device (10), the server device (10) being arranged to select assigned time points for transmission of subsequent detection messages (64b,c, 66b, 66c), and to send timing information that represents the assigned time points in reply to the detection messages (64a, 66a, 68a);
a plurality of client devices (10) coupled to the medium (12) and capable of requesting a service from the server device (10), the client devices (10) being arranged to send the detection messages to the server via the medium (12); the client devices being arranged to send renewed detection messages (64b,c, 66b, 68b) using the timing information to control a time of sending the renewed detection messages (64b,c, 66b, 68b) substantially at the assigned time points.

10. A server device (10) for use in a system that is arranged to accommodate a dynamically changing set of devices, the server device comprising:
an interface (22) for a communication medium (12);
a processing circuit (20) arranged to detect a detection message (64a, 66a, 68a) from a client device (10) for detecting an active connection of the server device (10) to the medium (12), the processing circuit (20) being arranged to compute timing information that represents an assigned time point for transmission of a subsequent detection message (64b,c, 66b, 68b) and to cause the interface (22) to send the timing information in reply to the detection message (64a, 66a, 68a).

11. A server device (10) according to claim 10, wherein the processing circuit (20) is arranged to select assigned time points for all of the plurality of testing devices (10) from a common series of time points that are progressively further into the future in a sequence corresponding to a sequence of arrival of the detection messages (64a, 66a, 68a).

12. A server device (10) according to claim 11, wherein the processing circuit (20) is arranged to compute the time point values T of the assigned time points by adding a duration vale D to preceding time point values T′ for a previously assigned time points.

13. A server device according to claim 12, wherein said duration value D has a fixed predetermined value.

14. A server device according to claim 12, wherein the processing circuit (20) is arranged to adapt said duration value D dynamically to a number of client devices that send detection messages (64a, 66a, 68a), so that the duration is increased and decreased as the number of testing devices (10) decreases or increases respectively, while ensuring that no less than a predetermined minimum time interval occurs between successive assigned time points of a particular testing device (10).

15. A server device according to claim 12, comprising a clock circuit (24), the processing circuit (20) being arranged to compute the time point value for an initial assigned time point by adding a duration D to a current time value T₀ obtained from the clock circuit (24).

16. A server device according to claim 10, wherein the processing circuit (20) is arranged to select the timing information that is sent to successively received detection messages (64a, 66a, 68a), from at least a first and second series wherein the timing information from each series represents assigned time points that are progressively further into the future, timing information from the second series being sent to a delay limiting fraction of the detection messages, so that a delay, between the time points of the second series and times at which time points from the second series or transmitted, at least on average does not exceed a predetermined delay, irrespective of a rate of reception of the detection messages.

17. A server device according to claim 10, wherein the processing circuit (20) is arranged to detect whether a detection message (64a, 66a, 68a) is a retry of a detection message that the server device (10) has previously responded to and to resend previously sent timing information in response to the retried detection message (64a, 66a, 68a).

18. A computer program product, containing machine instructions which, when executed by a programmable processing circuit make that programmable processing circuit function as the processing circuit of the server device according to claim 10.

19. A client device for use in a system that is arranged to accommodate a dynamically changing set of devices, the client device comprising:
an interface (22) for a communication medium (12);
a memory (26) for storing information about the active presence of a server device (12) in the system;
a processing circuit (20) arranged send detection messages (64a, 66a, 68a) to the server device (10) via the medium (12) and to receive back responses to the detection messages (64a, 66a, 68a), the processing circuit recording an end of active presence of the server device (10) in the memory (26) when no response to a detection message (64a, 66a, 68a) is received back, the processing circuit (20) being arranged to select a time point for sending at least one of the detection messages (64b,c, 66b, 68b) according to a time point represented in a preceding response.

20. A client device according to claim 19, wherein the preceding response represents a delay value, the client device comprising a clock circuit, the processing circuit (20) being arranged to delay transmission of said at least one of the detection messages (64b,c, 66b, 68b) until the clock circuit indicates that a time interval corresponding to the delay value has elapsed after reception of the preceding response.

21. A client device according to claim 19, wherein the processing circuit (20) is arranged extract addresses of fellow clients from the responses and to send proxy bye messages to the extracted addresses when the end of active presence of the server device is recorded.

22. A computer program product, containing machine instructions which, when executed by a programmable processing circuit make that programmable processing circuit function as the processing circuit of the client device according to claim 19.
